(19) United States
(12) Patent Application Publication
(10) Pub. No.: US 2006/0057980 A1
(43) Pub. Date: Mar. 16, 2006

(54) Transmitter circuit with modulated power amplifier bias control based on RF carrier envelope tracking

(75) Inventors: Tanbir Haque, Long Island City, NY (US); Leonid Kazakevich, Plainview, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/195,887

(22) Filed: Aug. 3, 2005

Related U.S. Application Data
(60) Provisional application No. 60/598,789, filed on Aug. 4, 2004.

(51) Int. Cl. H01Q 11/12; H04B 1/04

(52) U.S. Cl. 455/127.1; 455/126

(57) ABSTRACT

The present invention is a transmitter circuit in which envelope tracking of a power amplifier output is used to derive its power supply modulation. The circuit includes a power amplifier for amplifying an RF signal, a voltage power source and a switching amplifier for producing a modulated output responsive to the envelope of the amplified RF signal. The transmitter circuit further comprises a peak detector that eliminates the transmit carrier signal in the power supply modulation signal. A fraction of the PA output is utilized by the switching amplifier and the peak detector to produce a signal that follows the baseband signal envelope and is used to modulate the bias of the power amplifier.

### CROSS REFERENCE TO RELATED APPLICATION(S)

This application claims the benefit of U.S. Provisional Application No. 60/598,789 filed on Aug. 4, 2004, which is incorporated by reference as if fully set forth.

### FIELD OF INVENTION

The present invention relates to power amplifier (PA) design. More particularly, the present invention relates to a circuitry that controls the biasing of a PA by tracking the envelope of a radio frequency (RF) carrier signal that is amplified by the PA.

### BACKGROUND

Wireless communications between a fixed base station and fixed or mobile wireless transmit/receive units (WTRUs) take place over an air interface using various modulation techniques. The modulation technique chosen in Europe, (Gaussian minimum shift-keying), for second generation systems is a constant envelope technique. Elsewhere, standard phase shift keying (PSK) forms of modulation are used, such as differential PSK (DPSK) with raised cosine filtering, which is a non-constant envelope technique. The PSK modulation techniques are used in direct sequence spread spectrum systems.

Constant envelope techniques ensure that the envelope of a transmitted signal is a constant. This allows a PA used by the WTRU or base station to operate near saturation without distorting the RF signal. The most efficient operation of a PA is near saturation, as this is when the power added efficiency is greatest. The disadvantage of constant envelope modulation techniques is that the bandwidth efficiency is small relative to modulation techniques that have fluctuating envelopes.

In contrast, non-constant envelope modulation techniques require substantial linear amplification in order to preserve the signal shape. Nonlinearities applied to a non-constant envelope technique create both adjacent channel power and in-band intermodulation distortion. The adjacent channel power essentially widens the bandwidth occupancy of the signal while the in-band intermodulation distortion may be interpreted as being additional noise in the system.

No substantial distortion is incurred when linear amplification is used with non-constant envelope modulation techniques. However, linear amplification is possible when operating a PA with a small input signal, where the energy efficiency of the PA is smallest. This characteristic of nonlinear PAs makes large power efficiency and bandwidth efficiency hard to achieve simultaneously.

A current and emerging market trend in WTRUs employs heavy class AB power amplifiers, (i.e., close to class B), for constant envelope modulation schemes and weak class AB PAs, (i.e., close to class A), for non-constant envelope modulation schemes. Furthermore, some WTRU PAs employ class AB power amplifiers with a sliding bias to enhance the overall transmitter efficiency and extend battery life. Typically, the PA bias current is changed in proportion to the average transmitted power. The bias current is reduced when a transmitter circuit including the PA is commanded to back off from maximum output power, thereby preserving the peak efficiency over more of the operating range. However, the performance of existing class AB PAs for preserving the peak efficiency over the range of a non-constant envelope signal is limited.

Large scale transmitters are known to employ “envelope tracking” systems that modulate the power supply of the PA bias to closely follow the instantaneous envelope of the transmitted signal, thereby preserving the peak efficiency over more of the operating range.

FIG. 1 is a block diagram of a conventional transmitter circuit 100 used in a base station or a WTRU which outputs an RF carrier signal (RF_{OUT}) and controls a PA bias based on the envelope of an RF carrier signal input to the PA. The transmitter circuit 100 includes a modem 105, a chain of linear amplifiers 110A, 110B, an envelope extractor 115, three digital to analog converters (DACs) 116, 117, 118, an upconverter 119, a lowpass filter 121, a PA power supply modulator 120 and a PA 125. The modem 105 generates a desired baseband signal which is passed through DACs 117, 118, up-converted by the upconverter 119, and sent through the chain of linear amplifiers 110A, 110B via in-phase (I) and quadrature (Q) paths 130A. Additionally, the envelope of the desired signal is extracted and sent to the PA power supply modulator 120 via I and Q paths 130B. The PA power supply modulator 120 generates a modulated supply voltage 135 for the PA 125, typically at three to five times the RF bandwidth, which maintains it at or near saturation over the instantaneous dynamic range of the desired signal. The elaborate scheme used by the transmitter circuit 100 is too complex and unsuitable for a small scale transmitter.

FIG. 2 is a block diagram of another conventional transmitter circuit 200 which controls a PA 205 based on the envelope of an RF carrier signal input to the PA 205. In addition to the PA 205, which receives an RF carrier signal (RF_{IN}), the transmitter circuit 200 includes a coupler 210, a peak detector 215 and a clocked DC to DC converter 220. In this approach, a sample of the PA 205 output is fed to the peak detector 215 via the coupler 210. The peak detector 215 extracts the envelope of the sampled output of the PA 205. The peak detector 215 may include a diode 225 and a capacitor 230. The peak detector 215 outputs a signal to the clocked DC to DC converter 220, which generates a modulated supply voltage 235 for the PA 205. The drawback of this approach is that it requires an additional clock, (frequency equal to several multiples of the RF bandwidth of the signal), and large inductors (not suitable for integration) to implement the clocked DC to DC converter 220.

An efficient, low cost and low complexity transmitter circuit that employs envelope tracking in a small scale transmitter using non-constant envelope modulation is desired.

### SUMMARY

The present invention is a transmitter circuit that provides envelope tracking PA power supply modulation derived from the RF carrier at the output of the PA itself. The circuit includes a PA for amplifying an RF signal, a switching amplifier and peak detector for producing a modulated output responsive to the envelope of the amplified RF signal, a coupler, a voltage power source and an additional transistor in communication with the voltage source and the output of the peak detector. A fraction of the PA output is utilized by the switching amplifier and the peak detector to produce a signal that follows the baseband signal envelope and is used to modulate the voltage and/or current bias of the PA. By modulating the PA supply in this manner, it is ensured that the PA remains at or near saturation, and therefore it operates at a high level of efficiency over the instantaneous dynamic range of the signal. Additionally, a part of the switching amplifier output is added in phase coherence with the PA output to undo the gain compression at high output power levels.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a block diagram of a conventional transmitter circuit with an envelope tracking PA power supply modulator;

FIG. 2 is a block diagram of another conventional transmitter circuit with an envelope tracking PA power supply modulator; and

FIG. 3 is a block diagram of a transmitter circuit with an integrated carrier tracking power supply modulator which operates in accordance with the present invention.

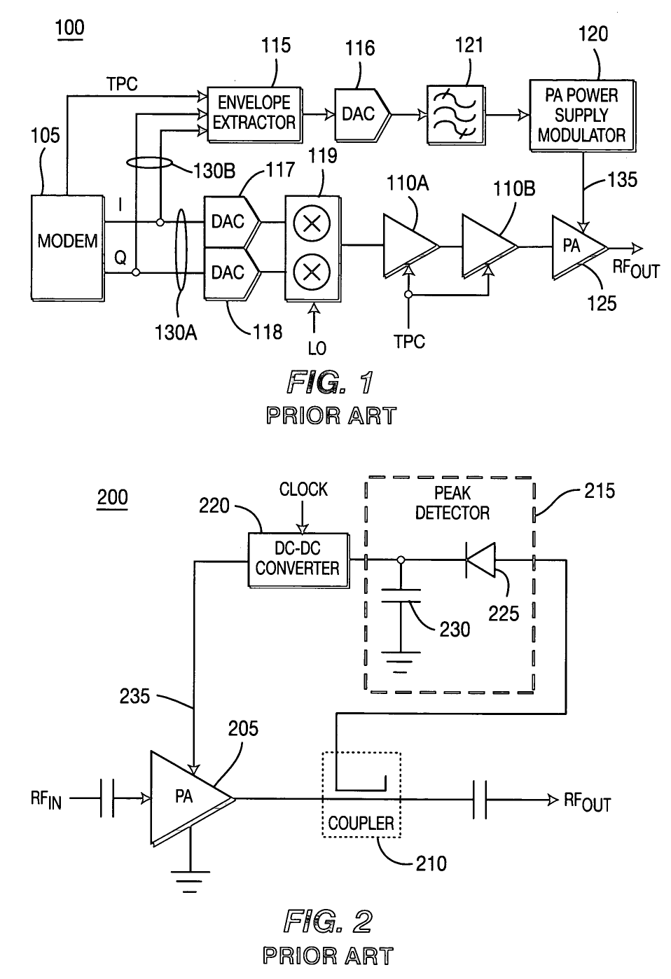

### DETAILED DESCRIPTION OF THE PREFERRED EMBODIMENT(S)

The present invention is a transmitter circuit that may be incorporated into a base station, a WTRU or the like. It should be noted that although the present invention will be described hereinafter as being used in wireless communication applications that require an efficient, low cost and low complexity transmitter circuit, the present invention is also applicable to wired applications.

Hereafter, the terminology “WTRU” includes but is not limited to a user equipment (UE), a mobile station, a laptop, a personal data assistant (PDA), a fixed or mobile subscriber unit, a pager, or any other type of device capable of operating in a wireless environment. When referred to hereafter, the terminology access point (AP) includes but is not limited to a base station, a Node-B, a site controller, an access point or any other type of interfacing device in a wireless environment.

The features of the present invention may be incorporated into an integrated circuit (IC) or be configured in a circuit comprising a multitude of interconnecting components.

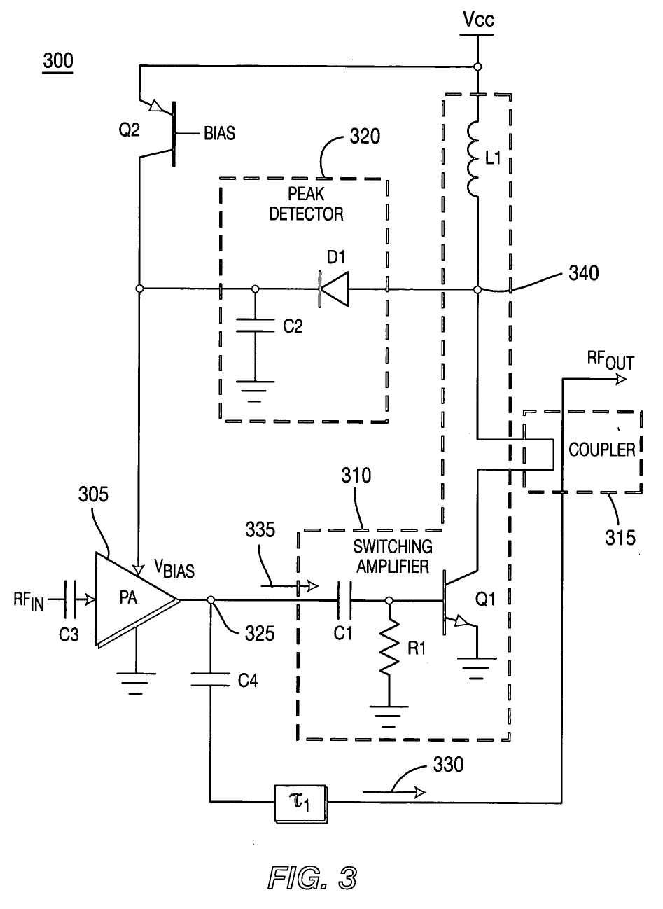

FIG. 3 shows a block diagram of an exemplary transmitter circuit 300 which processes an RF input signal (RF_{IN}) in accordance with the present invention. The transmitter circuit 300 comprises a PA 305, a switching amplifier 310, a coupler 315, and a peak detector 320. The PA 305 has a bias voltage input, V_{BIAS}. The PA 305 amplifies RF_{IN} and outputs an amplified signal to a node 325 in accordance with the V_{BIAS}.

The node 325 is connected to a first signal path 330 which provides an RF output (RF_{OUT}) of the transmitter circuit 300 via a time delay element τ1 and the coupler 315. The node 325 is also connected to an input of the switching amplifier 310 via a second signal path 335. The switching amplifier 310 includes a capacitor C1, a resistor R1, an inductor L1 and a transistor Q1. The capacitor C1 is coupled to the input of the switching amplifier 310, the base of the transistor Q1 and one end of the resistor R1. The other end of the resistor R1 and the emitter of the transistor Q1 are connected to ground. The collector of the transistor Q1 is fed through the coupler 315 to a node 340. The inductor L1 is connected between node 340 and a voltage source V_{CC}. The transistor Q1 may be a field effect transistor (FET) or a bipolar junction transistor (BJT). The biasing mechanism for transistor Q1 is resistor R1 coupled to ground at the switching amplifier 310, which is shown for simplicity. It should be known to one skilled in the art that other implementations of the biasing mechanism may be more complex. The coupler 315 couples a portion of the output of switching amplifier 310 and adds it to the output of the PA 305.

The transmitter circuit 300 further includes a transistor Q2. The emitter of the transistor Q2 is also connected to the voltage source V_{CC}. The transistor Q2 is biased, using an input source BIAS, such that it operates in saturation when sourcing current to the bias input of PA 305 (i.e., the voltage drop across the collector-emitter junction of Q2 is small). In an alternative embodiment, the transistor Q2 may be replaced by a forward biased diode. The collector of the transistor Q2 and an output of the peak detector 320 are connected to the V_{BIAS}.

The peak detector 320 includes a diode D1 and a capacitor C2. The diode D1 is connected between the node 340 and the collector of the transistor Q2. The capacitor C2 is connected between the collector of the transistor Q2 and ground. While the output of the switching amplifier 310 includes both the carrier and the baseband signal envelope, the peak detector 320 eliminates the RF carrier while preserving the signal envelope. The transmitter circuit 300 further includes coupling capacitors C3 and C4 which are used to remove DC from the input and the output of the PA 305, respectively.

The PA 305 derives a bias voltage and current from the bias voltage input V_{BIAS} such that the real part of the output impedance of the PA 305 remains constant. Additionally, the V_{BIAS} signal may be used by the PA to control either the bias voltage or the bias current alone. The bias voltage input V_{BIAS} may result from a first and/or second source. The first source is supply voltage V_{CC} coupled through the transistor Q2. The second source is the output of the peak detector 320.

Envelope tracking of the RF carrier signal amplified by the PA 305 is performed as follows. If the RF_{IN} signal is absent of alternating current (AC), the switching amplifier 310 is kept idle by the coupling capacitor C1, and the voltage bias input V_{BIAS} is pulled up to a voltage that is equal to the supply voltage V_{CC} minus the voltage drop across the transistor Q2.

When a variable AC signal is applied to the PA 305, a corresponding variable envelope results at the output of the PA 305. The switching amplifier 310 and the peak detector 320, in combination, modulate the bias input V_{BIAS} in proportion to the envelope of the output of the PA 305. The voltage at the node 340 oscillates between (V_{CC}+V_{PEAK}) and (V_{CC}−V_{PEAK}), where V_{PEAK} is the peak output voltage of the switching amplifier 310. Capacitors C1 and C4 are selected such that only a fraction of the output power of the PA 305 is fed to the input of the switching amplifier. Most of the transmit output power RF_{OUT} is sent to the antenna through capacitor C4.

It should be noted that the present invention has a built-in soft turn on/off action. When the average output power at the node 325 is relatively low, the modulation by the combination of the switching amplifier 310 and the peak detector 320 does not significantly disturb the bias voltage V_{BIAS}, even if large variations exist in the RF signal envelope at the node 325. By monitoring the node 325, the modulation variably activates only when it is needed, at relatively high average output power levels.

Linear operation of transmitter circuit 300 may be enhanced by selecting a proper coupling coefficient of the coupler 315 in conjunction with selection of the nominal gain of the switching amplifier 310, such that the signal contribution from the path 335 is significant to RF_{OUT} only when the gain of the PA 305 begins to compress, (i.e., when the PA 305 approaches saturation).

To ensure that the output of the switching amplifier 310 is added in phase coherence to the output of the PA 305, a timing delay element τ1 is inserted in the signal path 330 between the node 325 and the coupler 315. The constant time delay parameter of time delay element τ1 is selected by design based upon any delay inherent to devices in the signal path 330 relative to the devices in the signal path 335.

In summary, the transmitter circuit 300 includes a self-contained envelope tracking power supply modulation mechanism that requires only the RF carrier signal input, the supply voltage V_{CC}, and the BIAS input for transistor Q2. No additional control inputs or clock signals are required. Because the modulation is self contained, there is no need for separate modulation devices, such as modems. The transmitter circuit 300 can easily be integrated into a WTRU-grade transmitter architecture. It should be noted however, that the above mentioned envelope tracking power supply modulation may create amplitude modulation (AM) to phase modulation (PM) distortion in the PA 305, which may be corrected according to the teachings of U.S. patent application Ser. No. 10/713,613, filed Nov. 14, 2003, published as US 2004/0162104 A1 on Aug. 19, 2004.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A transmitter circuit for amplifying a radio frequency (RF) signal according to a bias voltage generated by the transmitter circuit, the transmitter circuit comprising:
a power amplifier for amplifying an RF signal having an input for the RF signal, a control input for bias of the power amplifier, and an output;
a power source for providing a constant voltage supply to the control input of the power amplifier; and
a switching amplifier for producing a modulated output in response to an envelope of the power amplifier output and for modulating the constant voltage supply to the control input of the power amplifier.

2. The transmitter circuit of claim 1 wherein the envelope of power amplifier output includes a baseband signal component and a transmit carrier signal component, the circuit further comprising:
a peak detector with an output coupled to control input of the power amplifier, responsive to the modulated output of the switching amplifier, configured to eliminate the transmit carrier signal component while preserving the power amplifier output envelope.

3. The transmitter circuit of claim 2 further comprising:
a transistor in communication with the constant voltage source and the peak detector, the transistor having an output coupled to the control input of the power amplifier, whereby the transistor is biased such that it operates in saturation and the bias of the power amplifier is controlled by the peak detector output or the transistor output, or a combination thereof.

4. The transmitter circuit of claim 3 wherein the switching amplifier is idle when no alternating current is present in the output of the power amplifier, and the bias voltage is pulled up to a voltage substantially equal to the voltage of the power source minus a voltage drop across the transistor.

5. The transmitter circuit of claim 2 further comprising:
a forward biased diode in communication with the constant voltage source, whereby the bias of the power amplifier is controlled by the peak detector output or the diode output, or a combination thereof.

6. The transmitter circuit of claim 1 further comprising:
a coupler having a first input in communication with the switching amplifier, a second input in communication with the power amplifier, a first output in communication with the peak detector, and a second output which sends the amplified RF signal to an antenna for transmission.

7. The transmitter circuit of claim 6 wherein the coupler combines the output of the switching amplifier with the amplified RF signal of the power amplifier to produce the output of the amplified RF signal.

8. The transmitter circuit of claim 7 wherein the coupler has a coupling coefficient such that the signal contribution from the switching amplifier output is significant to the amplified RF signal only when the gain of the power amplifier begins to compress.

9. The transmitter circuit of claim 6 further comprising:
a first capacitor having one end connected to the power amplifier; and
a time delay element coupled between the other end of the first capacitor and the second input of the coupler for maintaining phase coherence between the power amplifier and the switching amplifier output.

10. The transmitter circuit of claim 9 wherein the switching amplifier comprises a second capacitor, a resistor and a second transistor; wherein the first and second capacitors are configured such that most of the power amplifier output is directed to the path having the first capacitor.

11. The transmitter circuit of claim 1 further comprising:
a capacitor coupled to the input of the power amplifier for feeding the RF signal to the power amplifier.

12. A wireless transmit/receive unit (WTRU) comprising the transmitter circuit of claim 1.

13. A base station comprising the transmitter circuit of claim 1.

14. A transmitter circuit for amplifying a radio frequency (RF) signal according to a bias voltage generated by the transmitter circuit, the transmitter circuit comprising:
a power amplifier for amplifying an RF signal having an input for the RF signal, a control input for bias of the power amplifier, and an output, wherein an envelope of the power amplifier output includes a baseband signal component and a transmit carrier signal component;
a power source for providing a constant voltage supply to the control input of the power amplifier;
a switching amplifier for producing a modulated output in response to an envelope of the power amplifier's output and for modulating the constant voltage supply to the control input of the power amplifier; and
a peak detector with an output coupled to control input of the power amplifier, responsive to the modulated output of the switching amplifier, configured to eliminate the transmit carrier signal component while preserving the power amplifier output envelope.

15. The transmitter circuit of claim 14 wherein the peak detector comprises a diode and a capacitor.
